(19) United States
(12) Patent Application Publication
(10) Pub. No.: US 2008/0313892 A1
(43) Pub. Date: Dec. 25, 2008

(54) Process for Preparing a Cable End for the Installation of a Plug-In Connector

(75) Inventor: Walter Baldauf, Fridolfing (DE)

Correspondence Address: LAW OFFICE OF DELIO & PETERSON, LLC., 121 WHITNEY AVENUE, 3RD FLLOR, NEW HAVEN, CT, 06510, US

(73) Assignee: ROSENBERGER HOCHFREQUENZTECHNIK GMBH & CO. KG, Fridolfing (DE)

(21) Appl. No.: 11/915,598

(22) PCT Filed: May 19, 2006
(86) PCT No.: PCT/EP06/04789

§ 371 Date: Nov. 27, 2007

(30) Foreign Application Priority Data
May 30, 2005 (DE) 102005024683.4

(51) Int. Cl. H01R 43/04; H01B 13/20

(52) U.S. Cl. 29/828; 29/867; 29/861

(57) ABSTRACT

The invention relates to a process for preparing an end of a cable, especially a coaxial cable with an outer conductor, especially a braided outer conductor, for installing a plug-in connector, the outer conductor being exposed at the end of the cable, flared radially and bent back over a predetermined length in the axial direction away from the end of the coaxial cable. In the process, for flaring purposes, the outer conductor has a radial force applied to it over at lest part of the circumference of the cable.

This invention concerns a process for preparing an end of a cable, especially a coaxial cable, with an outside conductor, especially a braided outside conductor, for the installation of a plug-in connector, especially a coaxial plug-in connector, where the outside conductor is bared at the end of the cable, spread radially and bent backward in the axial direction away from the end of the cable, in accordance with the main concept of Claim 1.

For the installation of a plug-in connector on the end of a cable, for example, for the installation of a coaxial plug-in connector on the end of a coaxial cable, it is necessary to prepare the cable end in a corresponding manner so that, either manually or mechanically, the plug-in connector can be firmly connected mechanically and in such a manner as to conduct electricity to the end of the cable. This preparation of the cable includes, among other things, the baring and folding back of an outside conductor of the cable. After baring or removal of the insulation of the outside conductor, the latter is customarily first spread at the cable end so that, in a subsequent process, the outside conductor can be bent back away from the cable end in an axial direction without damaging the cable end. For this, it has previously customarily been necessary to direct an air jet against the cable end in an axial direction, which air enters radially inside the outside conductor and, as a result, opens the outside conductor radially outward. In this connection, however, the following disadvantages arise: The air jet does not affect only the outside conductor, but rather also the remainder of the cable inside the outside conductor. In this connection, it can occur, in an undesirable manner, that parts of the cable which are inside the outside conductor are spread out. Furthermore, the process security is not fully achieved, that is, that the compressed air jet possibly does not completely open the outside conductor or does not open it sufficiently. This can lead to an increased number of rejects or production errors. Therefore, it is often still necessary to carry out the folding back of the outside conductors manually and only then to move a cable so prepared into a machine to install the plug-in connector.

The problem to be solved by the invention is to simplify a process of the above-mentioned type for mass production and at the same time to improve it with respect to functional security.

This problem is solved according to the invention by means of a process of the above-mentioned type with the characteristics indicated in Claim 1. Advantageous embodiments of the invention are described in the further claims.

In the case of a process of the above-mentioned type, it is provided, according to the invention, that, in order to spread out the outside conductor over at least a portion of the circumference of the cable, a radial force is applied.

This has the advantage that in a simple and simultaneous manner the outside conductor can be spread open reliably and bent backwards. This achieves substantial savings with respect to cost and time, especially in mass production, since even the preparation of the cable end can be performed in a fully automated manner.

It is advantageous if the radial force generates a pressure which is less than the force which would be required for an at least partial cutting through of the outside conductor.

To support a crimping fastening of the plug-in connector on the cable end and to set the predetermined length in the axial direction from the end of the coaxial cable by which the outside conductor is to be bent back, after baring the outside conductor and opening it, a crimping shell is placed over the outside conductor and crimped onto the cable. In this connection, the outside conductor is bent in an axial direction up to an end of the cable which faces the end of the crimping shell.

In order to bend the outside conductor, after the widening, a shell is pushed into the opened end of the outside conductor in an axial direction.

In order to prevent the processing of the cable with a damaged part, possibly due to the force of widening the outside conductor after the outside conductor is bent over, the remainder of the cable which has been thus bared is cut at a point which is more distant in the axial direction from the end of the cable than the point at which the cable has had the radial force applied to spread the outside conductor.

The invention is described in greater detail in the following on the basis of the drawing. This shows:

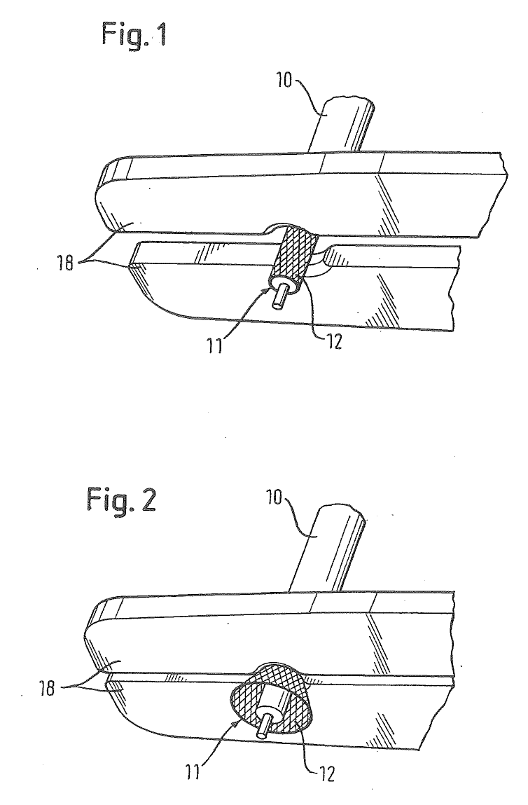

FIG. 1 an end of a coaxial cable after removal of insulation or baring of the outside braided conductor in a perspective view and

FIG. 2 the end of the coaxial cable after the spreading of the braided outside conductor by means of radially pressing the braided outside conductor with a corresponding tool in a perspective view.

The invention will be described below, only as an example, on the basis of a coaxial cable. The following explanations are, however, valid for any type of cable which is to be provided with a plug-in connector. In order to connect a coaxial cable with, for example, an electronic circuit on a printed circuit board, it is expected that one end of the coaxial cable be equipped with a coaxial plug-in connector. A corresponding complementary coaxial plug-in connector is provided on the circuit board.

In order to equip the end of a coaxial cable with a coaxial plug-in connector, this coaxial cable end must be correspondingly prepared. In this connection, it is first of all important to free the length of an outside covering, for example an insulation, around an outside conductor of the coaxial cable, for example in the form of a braided outside conductor over a predetermined length. The expression “bare” means, in this connection, essentially to free it from a covering such as, for example, insulation (remove the insulation).

The coaxial plug-in connector to be installed includes essentially an outside conductor portion, an inside conductor portion and an insulating portion lying between them. In a sample embodiment of the installation of the coaxial plug-in connector at the end of the coaxial cable, the coaxial plug-in connector is crimped onto the coaxial cable.

Regardless of the installation procedure for the coaxial plug-in connector, however, it is first necessary to bare the outside conductor of the coaxial cable and to bend it away from the end of the coaxial cable for a predetermined length in an axial direction. As a result, the inner portion of the coaxial cable is accessible, to which the inside conductor portion of the coaxial plug-in connector is fastened. Special difficulties arise in this connection in the bending of the outside conductor or the braided outside conductor of the coaxial cable. This can be done relatively simply by hand, but it is desirable to use a machine to perform this action for mass production. However, in order to make it possible for a tool to bend the outside braided conductor in an automated fashion, it is necessary first to spread the braided outside conductor at the end of the coaxial cable so that a corresponding tool can grasp under the braided outside conductor and bend it.

FIG. 1 shows the condition after removal of insulation from the coaxial cable 10 at a coaxial cable end 11, so that the braided outside conductor 12 is bared. Additionally, a crimping shell is pushed over the outside conductor 12 and crimped tightly. The axial length of removal of insulation and the axial length of the crimping shell are selected in this connection in such a manner that the end of the crimping shell facing the coaxial cable end 11 defines the distance from the coaxial cable end 11 up to which the braided outside conductor 12 is to be bent back.

In accordance with the invention, it is also provided that, before the bending back of the braided outside conductor 12, the braided outside conductor 12 at the end 11 of the coaxial cable 10 is spread open, for example, by the fact that a radial force is exerted on the outside conductor 12 by a tool resembling pliers. This force is chosen in such a manner that it exerts a pressure on the outside conductor 12 with the application surface of the tool, which is less than a pressure that would be necessary to cut through the outside conductor 12. In the embodiment shown according to FIG. 2, this tool is a form knife 18, which is adapted to the outside circumference of the coaxial cable 10 after removal of the insulation, and causes a corresponding radially placed or annular compression of the outside conductor 12, as a result of which the free end of the braided outside conductor 12 spreads radially. This radial pressure of the braided outside conductor 12 can easily be automated so that this preparation of the end 11 of the coaxial cable 10 can be carried out fully automatically and without manual intervention.

After spreading the braided outside conductor 12 by compressing it radially using the form knife 18, the bending of the braided outside conductor 12 in an axial direction from the end 11 of the coaxial cable 10 can be done. For this purpose, for example, a corresponding shell is pushed into the spread end of the braided outside conductor 12, which folds the braided outside conductor 12 back to the corresponding end of the crimping shell.

Subsequently, the internal conductor of the coaxial cable 10 can be bared or its insulation removed and it can be connected to the inside conductor portion, that is, the inside conductor portion is crimped onto the bared inside conductor of the coaxial cable 10. Thereafter, the insulating portion and the outside conductor portion are fastened by crimping. In this connection, the previously installed crimping shell serves as an internal baring to accept the crimping force in the area of the placement of the outside conductor portion on the folded outside conductor 12 of the cable 10 and in order to prevent damage to the coaxial cable 10, due to the crimping process, when fastening the outside conductor portion. Between the outside conductor portion and the crimping shell, therefore, a high compression force can be applied with a corresponding high quality of the electrical contact being assured without the danger of damaging the cable 10, since the crimping shell absorbs the corresponding forces.

With the crimping of the outside conductor part, both a good electrical connection between the outside conductor 12 and the coaxial cable 10 and the outside conducting portion as well as a good mechanical joint between the insulating covering of the coaxial cable 10 and a strain relief of the outside conductor portion is achieved.

It is especially advantageous that the entire process of installation of the plug-in connector on the cable, including the preparation of the cable with respect to the bending or folding back of the outside conductor, can be automated in a single device. A manual preparation of the end of the cable for the installation of the plug-in connector can be fully dispensed with.

1. A process for preparing a coaxial cable having a braided outside conductor for the installation of a coaxial plug-in connector, comprising:
baring the outside conductor at the end of the cable;
spreading said outside conductor radially and bending said outside conductor backward over a predetermined length in the axial direction from the end of the cable, wherein said spreading includes:
applying a radial force to the outside conductor over at least a part of the circumference of the cable, and
generating a radially surrounding, annular shaped impression on the outer conductor, so that the free end of the braided outside conductor spreads radially.

2. The process of claim 1 including applying the radial force in a magnitude smaller than a force necessary to generate an at least partial severing of the outside conductor.

3. The process of claim 1 including placing a crimping shell on the outside conductor and crimping said shell onto the cable after baring the outside conductor and before it is spread.

4. The process of claim 3 including bending the outside conductor backwards in an axial direction up to the end of the crimping shell facing the end of the cable.

5. The process of claim 1 including pushing a shell in the axial direction into the spread end of the outside conductor after the spreading.

6. The process of claim 1 including cutting off any remainder of the cable cleared of insulation-after the folding of the outside conductor, said cutting occurring at a point which is further in the axial direction from the end of the cable than the point at which the cable is to be subjected to the radial force in order to spread the outside conductor.

7. The process of claim 1 wherein said radial force is applied by inserting a form knife about the outside circumference of the coaxial cable from which the insulation has been removed.

8. A process for preparing a coaxial cable having a braided outside conductor for the installation of a coaxial plug-in connector, comprising:
baring the outside conductor at the end of the cable;
placing a crimping shell on the outside conductor and crimping said shell onto the cable after baring the outside conductor and before it is spread; and
spreading said outside conductor radially and bending said outside conductor backward over a predetermined length in the axial direction from the end of the cable, wherein said spreading includes:
applying a radial force to the outside conductor over at least a part of the circumference of the cable by inserting a form knife about the outside circumference of the coaxial cable from which the insulation has been removed, and
generating a radially surrounding, annular shaped impression on the outer conductor, so that the free end of the braided outside conductor spreads radially.
